(19) United States
(12) Patent Application Publication
(10) Pub. No.: US 2002/0003590 A1
(43) Pub. Date: Jan. 10, 2002

(54) Liquid crystal display device and fabrication method thereof

(76) Inventors: Young Yik Ko, Kyoungki-do (KR); Min Sub Kim, Kyoungki-do (KR)

Correspondence Address: LADAS & PARRY, 224 SOUTH MICHIGAN AVENUE, SUITE 1200, CHICAGO, IL, 60604, US

(21) Appl. No.: 09/898,993

(22) Filed: Jul. 3, 2001

(30) Foreign Application Priority Data
Jul. 4, 2000 (KR) 2000-37978

(51) Int. Cl. G02F 1/1333

(52) U.S. Cl. 349/54

(57) ABSTRACT

Disclosed is a liquid crystal display device and a fabrication method thereof comprises a data PCB substrate having a data pad block and a gate PCB substrate having a gate pad block; a data dummy pad and a gate dummy pad formed on the data PCB substrate and on the gate PCB substrate, respectively; and a repair redundancy line formed on the gate pad block and the data pad block to form a redundancy line path between them.

### BACKGROUND OF THE INVENTION

1. Field of the Invention

The present invention relates to a liquid crystal display device and, more particularly, to a liquid crystal display device capable of solving problems due to disconnection of signal line wiring by effectively connecting a repair line of an array substrate with a repair line of a printed circuit board (hereinafter referred to as PCB), thereby increasing yield and fabrication method thereof.

A conventional liquid crystal display device and fabrication method thereof will be described in conjunction with FIG. 1.

FIG. 1 is a drawing for showing a conventional PCB having a repair redundancy line thereon.

Referring to FIG. 1, when signal line wring is disconnected, a repair redundancy line 15 is formed on a PCB to eliminate problems.

However, according to the conventional method, a capacitor is formed between the redundancy line on the PCB and a ground, thereby causing repair line delay. As a result, a repair coverage area is decreased.

### SUMMARY OF THE INVENTION

The present invention has been made to solve the above problems of conventional method. The object of the present invention is to provide a liquid crystal display device and fabrication method thereof capable of effectively improving repair by eliminating parasitic capacitor between the repair redundancy line and the ground.

In order to achieve the above objects, the liquid crystal display device of the present invention comprises: a data PCB substrate having a data pad block and a gate PCB substrate having a gate pad block; a data dummy pad and a gate dummy pad formed on the data PCB substrate and on the gate PCB substrate, respectively; and a repair redundancy line formed on the gate pad block and the data pad block to form a redundancy line path between them.

And, the method of fabricating the liquid crystal display device according to the present invention comprises the steps of: forming a data dummy pad and a gate dummy pad on the data PCB substrate having the data pad block and the gate PCB substrate having the gate pad block, respectively; forming a first repair redundancy line forming a redundancy line path with the data dummy pad on the gate pad block; forming an insulating layer and a thin film transistor on the array substrate; forming a second repair redundancy line forming the redundancy line path with the gate dummy pad on the data pad block; forming a protective layer on the resulting structure including the thin film transistor; and forming a current path interconnecting the first and the second repair redundancy lines on the resulting structure.

In the above, in order to solve the problems from signal line disconnection, the number of repair redundancy lines on the edge of the active area in a panel is one or more to be connected into the PCB by TCP.

And, the current path of the repair redundancy line is connected through a dummy pad of a source pad.

In order to eliminate the parasitic capacitor between the repair redundancy line and the ground, the repair redundancy line is formed on the edge of the PCB and a ground is not formed thereon.

A current path of the repair redundancy line is not formed to data PCB by FPC but by a gate dummy pad bonded to gate PCB and by a data dummy pad bonded to data PCB.

### BRIEF DESCRIPTION OF THE DRAWINGS

The above objects, and other features and advantages of the present invention will become more apparent after a reading of the following detailed description when taken in conjunction with the drawings, in which:

FIG. 1 is a drawing for showing a conventional PCB having a repair redundancy line thereon.

FIG. 2 is a drawing for showing a PCB having a repair redundancy line thereon, according to the present invention.

FIG. 3 is a detailed drawing of A part in FIG. 2 according to the present invention.

FIG. 4 is a detailed drawing of B part in FIG. 2 according to the present invention.

FIG. 5 is a flow chart for showing a fabrication method of array substrate of liquid crystal display device according to the present invention.

### DETAILED DESCRIPTION OF THE PREFERRED EMBODIMENTS

The preferred embodiment of the present invention will be described in detail with reference to accompanying drawings.

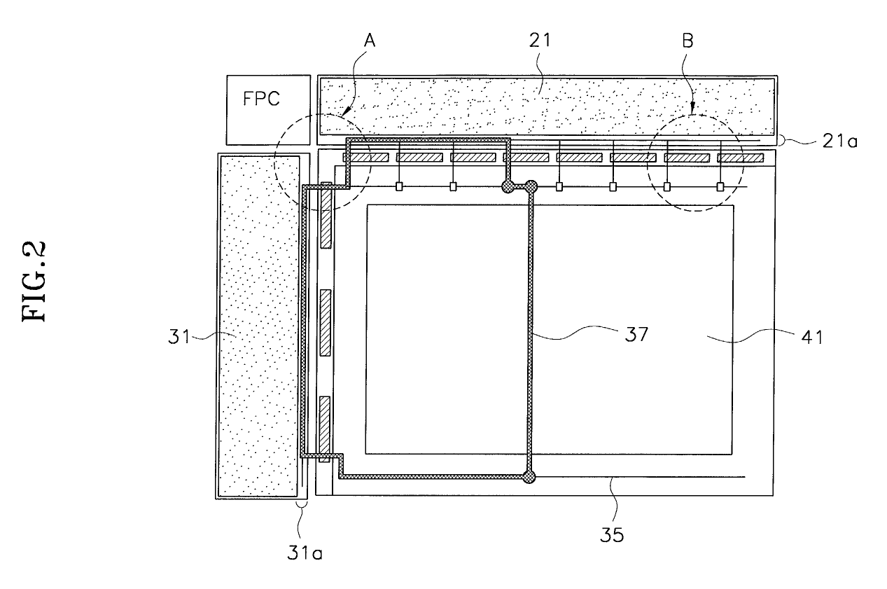

FIG. 2 is a drawing for showing a PCB having a repair redundancy line thereon, according to the present invention.

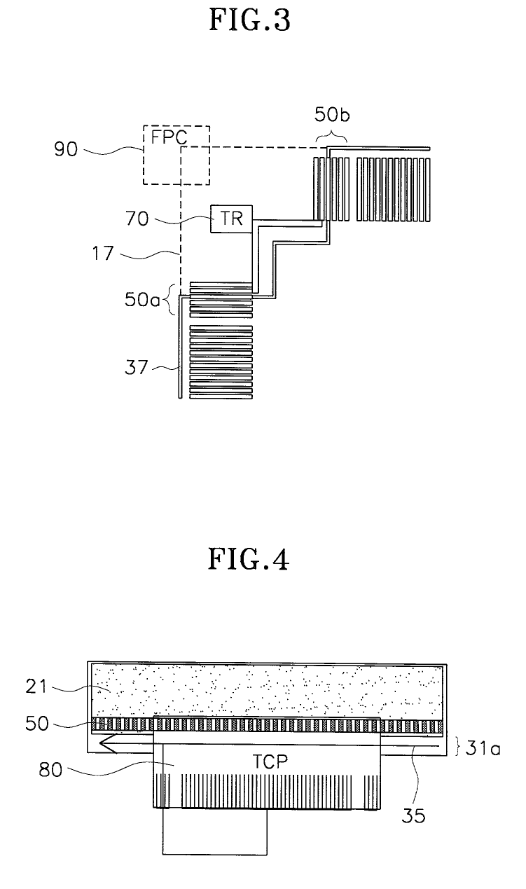

FIG. 3 is a detailed drawing of A part in FIG. 2 according to the present invention.

FIG. 4 is a detailed drawing of B part in FIG. 2 according to the present invention.

FIG. 5 is a flow chart for showing a fabrication method of array substrate of liquid crystal display device according to the present invention.

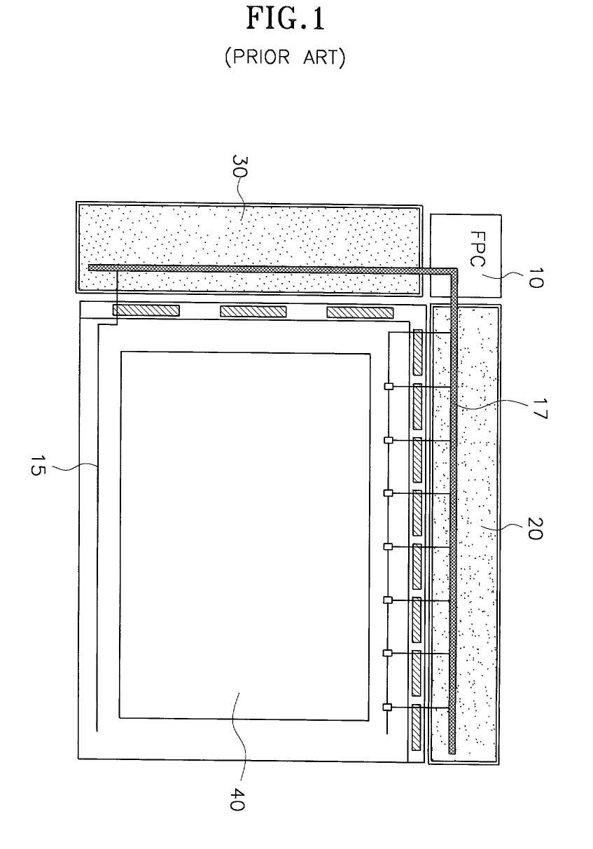

Referring to FIG. 2, according to the present invention, a repair redundancy line 35 is formed differently from the repair redundancy line 15 according to a conventional method as shown in FIG. 1.

Referring to FIG. 3, a drawing number 17 is a current path of repair redundancy line according to a conventional method and a drawing number 37 is that according to the present invention.

Referring to FIG. 4, a repair redundancy line 35 is formed on a part wherein capacitor is not generated with a ground in a PCB substrate.

On the other hand, according to the present invention, an array substrate is fabricated by forming an address wiring on an array substrate and at the same time forming a repair line to form a redundancy line path with a data dummy pad on a gate dummy pad.

Then, an insulating layer is formed on the array substrate and a-Si layer is formed as a channel layer of thin film transistor.

Subsequently, in forming signal line wiring, a repair line to form the redundancy line path with the gate dummy pad is formed on the data dummy pad.

And, a protective layer made of SiNx is formed on the thin film transistor in order to protect the thin film transistor.

And then, a pixel electrode made of ITO and additional capacitor are formed at the same time and a current path is formed to interconnect the repair lines.

The liquid crystal display device having the above array substrate has a thin film display device on one substrate and a color filter on the other substrate. And, in order to solve problems from signal line disconnection, the repair redundancy line 35 is formed on the edge of active area in the panel.

And, the number of the repair redundancy line 35 formed on the edge of the active area 41 in the panel is one or more to be connected into the PCB through TCP 80.

Additionally, the current path 37 of the repair redundancy line 35 is connected to that of a dummy pad of the gate pad through a dummy pad of the data pad and the repair redundancy line 35 is formed on the edge of PCB to eliminate capacitor with ground.

And, in the repair redundancy line 35, the current path 37 is formed through the data dummy pad bonded to data PCB and through the gate dummy pad 50 bonded to gate PCB unlike the conventional method in that the current path 17 is formed on the gate PCB by FPC 90.

Referring to FIGS. 2 and 3, repair redundancy lines 35 are formed on a gate dummy pad 50b of the closest gate pad block 31a transferring from the data PCB substrate 21 to the gate PCB substrate 31 and on a data dummy pad 50a of the data pad 21. Here, the gate pad 31 and the data pad 21 has different metal formation process. Therefore, via hole is formed and a current path 37 is formed by connecting each other in formation of ITO.

If the data PCB substrate and the gate PCB are interconnected by a FPC 90 as in a conventional method, capacitor is formed between ground and repair line, thereby causing repair line delay. And, if the repair current path 37 is formed in order to prevent generation of capacitor, the structures of X and Y PCBs become complicated.

Accordingly, as shown in FIG. 4, instead of ground, a plurality of repair redundancy lines are formed on the edge of PCB pad of PCB substrate.

If a ground pattern is formed on the part wherein the repair redundancy line may be formed, capacitor is formed, thereby causing repair line delay. Therefore, it is essential not to form the ground pattern in the process of forming PCB.

As described above, according to the present invention, the repair redundancy line is formed on the edge of PCB, wherein the ground pattern is not formed. Therefore, capacitor is not generated between the ground and the repair redundancy line and thereby repair line delay is prevented.

Moreover, a circuit diagram of PCB substrate is simplified since the current path is formed in a cell, not in the FPC.

What is claimed is:

1. A liquid crystal display device comprising:
a data PCB substrate having a data pad and a gate PCB substrate having a gate pad;
a data dummy pad and a gate dummy pad formed on the data PCB substrate and the gate PCB substrate, respectively; and
a repair redundancy line formed on the gate pad block and the data pad block to form a redundancy line path between them.

2. The liquid crystal display device according to claim 1, wherein the one or more repair redundancy lines are formed to solve problems from signal line disconnection on a data PCB substrate and on a gate PCB substrate where a ground pattern is not formed and to be connected into the PCB substrates through TCP on the data PCB substrate and the gate PCB substrate.

3. The liquid crystal display device according to claim 2, wherein the current path of the repair redundancy line is connected by a dummy pad formed on the data pad block of data PCB substrate.

4. The liquid crystal display device according to claim 2, wherein the repair redundancy lines on the PCB substrates are formed on the edge of the PCB substrate in order to eliminate capacitor with a ground.

5. The liquid crystal display device according to claim 3, wherein the current path is formed on a data dummy pad block bonded to the data PCB substrate and a gate dummy pad block bonded to the gate PCB substrate.

6. A method of fabricating liquid crystal display device comprising the steps of:
forming a data dummy pad on a data PCB substrate having a data pad block and forming a gate dummy pad on a gate PCB substrate having a gate pad block, respectively;
forming a first repair redundancy line to form a redundancy line path with the data dummy pad on the gate pad block;
forming an insulating layer and a thin film transistor on the array substrate;
forming a second repair redundancy line to form the redundancy line path with the gate dummy pad on the data pad block;
forming a protective layer on the resulting structure including the thin film transistor; and
forming a current path interconnecting the first and the second repair redundancy lines on the resulting structure.

7. The method of fabricating liquid crystal display device according to claim 6, wherein the first and the second repair redundancy lines are formed to solve problems from signal line disconnection on the edge of the active area in a panel and the number is one or more to be connected into the PCB through TCP on the PCB.

8. The method of fabricating liquid crystal display device according to claim 6, wherein the current paths of the first and the second repair redundancy lines are connected by a data dummy pad of data pad block.

9. The method of fabricating liquid crystal display device according to claim 7, wherein the repair redundancy line on the PCB is formed on the edge of the PCB in order to eliminate capacitor with a ground.

10. The method of fabricating liquid crystal display device according to claim 9, wherein the current paths of the repair redundancy lines are formed on the data dummy pad bonded to the data PCB substrate and on the gate dummy pad bonded to the gate PCB substrate.
